(19) United States
(12) Patent Application Publication
(10) Pub. No.: US 2009/0077099 A1
(43) Pub. Date: Mar. 19, 2009

(54) Method and Infrastructure for Storing Application Data in a Grid Application and Storage System

(75) Inventors: Nils Haustein, Soergenloch (DE); Sven Oehme, Ober-Hilbersheim (DE); Ulf Troppens, Mainz (DE); Rainer Wolafka, Bad Soden (DE)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 12/184,316

(22) Filed: Aug. 1, 2008

(30) Foreign Application Priority Data
Sep. 18, 2007 (DE) 07116623.5
Sep. 18, 2007 (EP) 07116623.5

(51) Int. Cl. G06F 17/30

(52) U.S. Cl. 707/10; 707/E17.032

(57) ABSTRACT

A grid application and storage system to enhance data access. The grid application and storage system comprises a plurality of grid application storage nodes with at least one storage system, said grid application storage nodes being remote to each other and connected via inter-connections; at least one application process distributed across said grid application storage nodes; and at least one grid node control process also distributed across said grid application storage nodes, said grid node control process managing grid application storage node operations. A plurality of client systems are connected to said grid application and storage system via a network for deploying said application process and accessing application data stored on said grid application storage nodes.

### BACKGROUND OF THE INVENTION

1. Field of the Invention

In general, the present invention relates to a method for storing application data in a grid application and storage system, which comprises a plurality of grid application storage nodes with at least one storage system. These grid application storage nodes are remote to each other and connected via inter-connections. In terms of the invention, at least one application process managing business processes is distributed across said grid application storage nodes. Besides, at least one grid node control process is distributed across said grid application storage nodes, which manages grid application storage node operations. In the context of this invention, a plurality of client systems are connected to said grid application and storage system via a network and are thus able to deploy said application process and access application data stored on said grid application storage nodes.

2. Description of the Related Art

A grid application and storage system 100 according to prior art is shown in FIG. 1 and explained in connection therewith. This grid application and storage system 100 is represented by a plurality of grid application storage nodes 120-123 being connected by interconnections 124. In the following, the term grid node is used to denote said grid application storage nodes. Grid nodes 120-123 are typically installed in different locations. For example node 120 and 121 might be installed in Mainz (Germany) and node 122 and 123 might be installed in Tucson (Ariz.). The interconnections 124 allow transferring data between the grid nodes 120-123 and may comprise one or more networks. Such a network may be based on Ethernet using the TCPIP, iSCSI or INFINIBAND protocol; or it can be based on Fibre Channel including the Fiber Channel Protocol.

The grid nodes 120-123 are essentially application and storage systems. Distributed across said grid nodes 120-123 are grid node control processes 130 and an application process 133. Each grid node 120-123 comprises actual storage systems 131, 132 for storing application data. These storage systems 131, 132 might be based on disk drive technology 131, tape drive technology 132 or optical technology.

The grid node control processes 130 manage grid node operations. Therefore, grid node control processes 130 essentially virtualize the underlying grid application and storage system infrastructure, i.e., storage systems 131, 132, and application process 133. The virtualization is done across different locations, such as Mainz and Tucson allowing users to access data in grid application and storage system 100 independent of their location. Thus, a user working in Mainz today is able to access the same data from a workstation in Tucson tomorrow. Grid node control processes 130 essentially implement methods for placing the data on grid nodes. The actual location of the data is fully transparent to the users. Grid node control processes 130 also comprise replication policies controlling the storage of data objects on one or more grid nodes.

Application processes 133 are business applications such as an enterprise content management system (ECM). Application processes 133 may be one enterprise content management system which runs in a distributed environment on the plurality of grid nodes 120-123. In this case, any given client node 102-103—explained in the following—communicates to the same instance of the ECM. Application processes 133 may also run as separate instances on each grid application storage node 120-123. In this case, the application processes 133 communicate among each other for example using a standardized protocol like iECM. Grid node control processes 130 and application processes 133 may be represented by one process.

A plurality of client systems 102-104 are connected to the grid application and storage system 100 via network 110. Client systems 102-104 are user's workstations often residing in different locations, for example client system 102 may reside in Mainz (Germany) and client system 103 may reside in Tucson (Ariz.). The network 110, connecting the client systems 102-104 to the grid application and storage system 100, can be based on Ethernet using the TCPIP, iSCSI or INFINIBAND protocol; or it can be based on Storage Area Network (SAN) including the Fibre Channel Protocol.

The client systems 102, 103, 104 communicate to the business application 133, which is distributed across multiple grid nodes 120-123. Therefore, the client systems deploy the application specific protocol which might be based on the standardized Java Content Repository (JSR-170, JSR-283). That protocol allows clients to search for data (query), read data (get operation), write data (insert data) and update data (update operation) stored in the grid application and storage system 100. Grid node control processes 130 in conjunction with business application 133 virtualizes the plurality of grid nodes and make it look like one system to the client.

When data is written from a client system 102-104 to business application 133 it is transferred through the network 110 and grid node control processes 130 of all or a subset of grid nodes 120-123 to decide where, i.e., on which node 120-123, the data is to be stored based on preconfigured policies. Thereby, the data might be stored in a grid node 120 located in Mainz and in a grid node 122 located in Tucson. The transfer of the data to the grid node 122 in Tucson may be performed via interconnection 124.

When data is read from a client system 102 located in Mainz the read request is sent to the grid node control processes 130 and business application 133 of all or a subset of grid nodes 120-123. When a business application 133 finds the data it sends it back to the client system 102.

Updates to a given data object are issued to all grid nodes 120-123 which store said data object.

As described above, prior art grid application and storage systems 100 comprising business applications 133 allow storing application data on geographically dispersed grid nodes 120-123. However, the prior art policies for distributing the data to different grid nodes 120-123 is inflexible and has no notion of the user location. This causes either a waste of grid storage capacity since the data must be distributed to all nodes or it causes access performance impacts for the user since the data may have to be accessed from a remote grid node which might be far away and only accessible over an expensive data line.

### OBJECT OF THE INVENTION

Starting from this, object of the present invention is to enhance the access to data stored in a grid application and storage system.

### SUMMARY OF THE INVENTION

The foregoing object is achieved by a method and an infrastructure as laid out in the independent claims. Further advantageous embodiments of the present invention are described in the subclaims and are taught in the following description.

According to the present invention the claimed method is characterized by determining the location of at least one client system defined for accessing the application data to be stored, by determining the location of at least a subset of the grid nodes of said grid application and storage system, and by storing said application data on at least one selected grid node of said subset, wherein the selection is based on the relation between the location of said client system and the locations of the grid nodes of said subset. The claimed infrastructure is configured accordingly to perform this method.

Thus, the invention provides means for controlling the placement of application data in a grid application and storage system taking into account the varying location of a user. In the context of the present invention, the user location is represented by a client system defined for accessing given application data. The methods proposed by the invention are designed for a grid application and storage system running a business application. They allow the storing of given application data at the closest and least expensive grid node. Thereby, the preferred grid node is selected based on the current or future user location.

The current user location is determined by the location the user, i.e., the corresponding client system, resides on at a given point of time. The current user location can be determined by different means according to prior art such as the TCPIP address, MAC address or name of the client system.

According to a preferred embodiment of the present invention, the future user location is determined by user travel information provided by other systems and communicated to the grid application and storage system. Thus, the future location of a user may be determined in advance by a travel booking system—when the user books a flight from location A to location B. Or it may be determined by the user's electronic calendar—when the user enters a meeting taking place in a different location. Or it might be transferred by a medical patient management system—when the user is referred to another hospital for a special treatment.

The least expensive grid node is defined by the distance and cost of the network between the grid node and the client system as well as by the utilization of the grid node at a given time.

For each data insert or update operation, i.e., write operation, there is at least one preferred grid node selected based on the location of the client system and the location of grid nodes. If there are multiple grid nodes matching the client system location criteria the preferred grid node is selected based on the used capacity and the current utilization of the eligible grid nodes. Thereby, the grid node with the least current utilization and the least used capacity is selected as the preferred grid node. Usually, the preferred grid node has write-authority for a given data object. Data may be duplicated to other grid nodes according to policies whereby other grid nodes may only facilitate read-authority. In an alternate embodiment there may be more than one preferred grid node for any given data object. The preferred grid node can also be pre-defined by the user.

According to another preferred embodiment of the present invention the preferred grid node for accessing given application data may be changed, if required, by migrating said application data to a new preferred grid node, wherein data migration is done by database export and import operations. In this case it is often useful to transfer the write-permission to the new preferred grid node, too.

The migration of application data may be initiated automatically whenever the user location changes. Those changes can be recognized easily by monitoring the user location when accessing data objects. In an alternate embodiment the application data is automatically transferred to a new location, i.e., grid node, in the background “before” the user actually needs access to the data. This is triggered by an external system such as a travel booking system or the user's electronic calendar or a patient management system. When the user location is going to change then the inventive system incorporates methods pertaining to the grid control processes and business application migrating the data from one grid node to another. The migration of the data might be based on database export and import operations. The migration of the data is done pro-actively in order to prevent impacts when the user accesses the data. This allows to dynamically adjust the location of the data to the user location preventing long data access times and the use of expensive data lines.

### BRIEF DESCRIPTION OF THE DRAWINGS

The novel features of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a diagram illustrating the structure of a prior art grid application and storage system 100, embedded in an infrastructure according to the present invention;

FIG. 2 shows a flowchart illustrating a process for selecting a preferred storage node according to the invention; and

FIG. 3 shows a flowchart illustrating a process for reassigning a preferred storage node according to the invention.

### DETAILED DESCRIPTION OF THE INVENTION

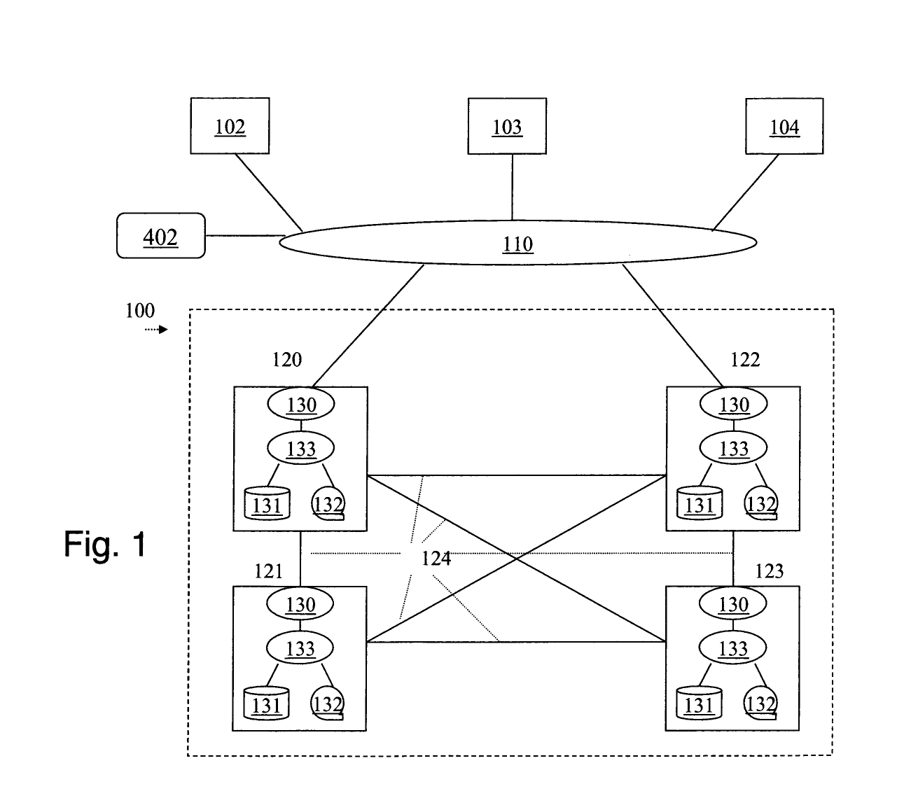

The structure of grid application and storage system 100 shown in FIG. 1 has already been described above as starting point of the present invention. The processes necessary for storing application data in such a grid application and storage system 100 according to the invention are implemented in the grid node control processes 130 and the business application processes 133 of all grid nodes 120-123 pertaining to the grid application and storage system 100.

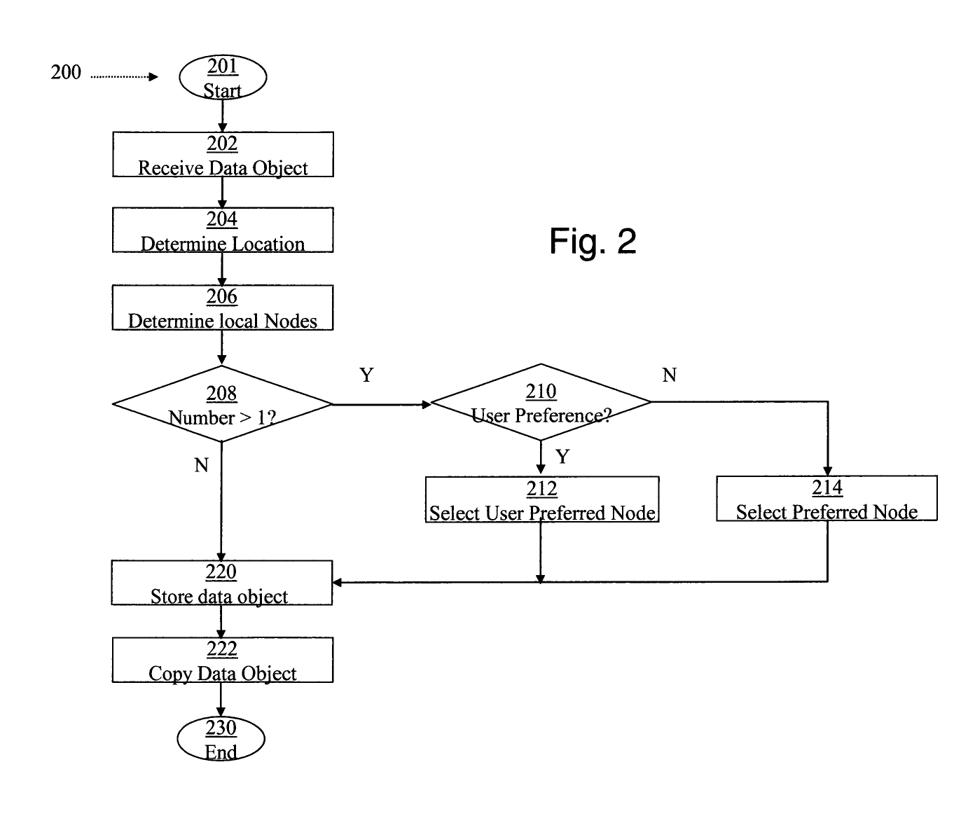

The first inventive process 200, illustrated in detail in FIG. 2, teaches a method for selecting the closest and least expensive grid node for a given data insert or update operation. Therefore the location of a client system (102-104) must be determined. Determining the client location can be done in different reactive manners such as by identifying the address or name of the client system. Thereby naming and addressing conventions for client systems must be established allowing associating a location to each address and/or name. For example client systems located in Mainz (according to FIG. 1) may have TCPIP addresses of 9.155.x.x and client systems located in Tucson may have addresses of 9.156.x.x. Likewise the client system name may start with MZ for clients located in Mainz and TUC for client systems located in Tucson. The inventive method includes the naming conventions and can associate a data access done by a user via a client system with a location of the user. The address or name of the client system is thereby given in each data access request issued from a client system to the grid application and storage system 100.

Determining the user location can also be done in a proactive manner using an electronic travel system 402 connected to the grid application and storage system 100 via network 110 as shown in FIG. 1. Travel system 402 and grid application and storage system 100 communicate via network 110. Thereby travel system 402 communicates with grid control processes 130 of all or a subset of grid nodes 120-123. Travel system 402 informs grid control processes 130 that a user is going to travel using a message. In this message, which might be based on TCPIP, the travel system 402 can inform the grid control process 130 about the new location of the user, i.e., the destination location of the user's journey.

As mentioned above, process 200 shown in FIG. 2 is used to select the preferred grid node for a data object insert operation based on the current or planned user location. This process is implemented in the grid node control processes 130.

The process 200 starts in step 201 and continues to step 202 where the insert request by a user via a client system 102-104 is received by the grid node control process 130. If grid node control processes of multiple grid nodes receive the insert request than they negotiate among each other that the request is only processed by one grid node. Hence process 200 is executed by one grid node control process of one grid node. The grid node control process 130 identifies the location of the user in step 204 based on methods described above.

Then, in step 206 the grid node control process 130 determines the grid nodes located close to the user location which are referred to as local nodes. Thereby, the grid control process 130 may compare the distance between the grid nodes and the user location against a distance threshold. All grid nodes in a distance below such threshold are selected as local nodes. If for a given distance threshold no local node is determined then the distance threshold is incremented until at least one local grid node has been determined in step 206.

In the next step 208 the grid control process 130 decides whether the number of local nodes determined in step 206 is greater than 1. If the answer in this step is no the process continues to step 220 explained later. Otherwise, if the answer in step 208 is yes the process continues to step 210 where it determines if there are any user defined preferences for the grid node selection and if the predefined node is included in the set of local nodes selected in step 206. If the answer in step 210 is yes the process continues to step 212 where the user preferred node is selected. Otherwise, if the answer in step 210 is no the process continues to step 214 where the preferred grid node is selected. The “best” grid node is determined by the node which is least utilized and has most capacity. In an alternate embodiment a node may be selected where other data of initiating client system is stored.

The selection of the preferred grid node in steps 212 and 214 may not be limited to select just one preferred storage node, but multiple preferred storage grid nodes can be selected where a copy of the data object is stored. For example for the client system 102 located in Mainz the grid nodes 120 and 121 might be preferred grid nodes for the data of said client system.

From steps 212 and 214 the process flows to step 220 where the data is stored in the selected preferred grid node. Thereby the grid node control process of the performing process 200 instructs the grid node control process of the preferred grid node to store the data. The store operation is managed by the application process 133 of the preferred grid node. This application process 133 also stores the relation between data and user and client system respectively.

From step 220 the process flows to step 222 where a copy of the data object might be copied to other grid nodes selected in step 212 or 214. The copy process is also executed by the business application 133 of the preferred grid node which has just stored the data in step 220. This data copy residing on other grid nodes but the preferred node only has read permissions compared to the data copy on the preferred node which allows writing and updates in addition to reads. The distribution of data object copies to other grid nodes is based on prior art methods, such as policies configured in the grid management system.

Process 200 ends in step 230. This ending step 230 may include sending a confirmation to the client system that the data object has been stored.

The preferred grid node or nodes selected for each data object by process 200 and stored in a grid application and storage system 100 allow read-write access whereas other grid nodes storing a copy of the data do allow read-only access. If write data access occurs from a client system to a distant preferred node then this is done by pass through methods incorporated in the control processes 130 of grid nodes. For example if the preferred node is node 120 located in Mainz and a write access is received by grid node 122 located in Tucson then node 122 utilizes the pass through method to write the data to preferred node 120 via interconnection 124. Of cause this impacts the performance and uses expensive data lines, therefore a method is required to reassign the preferred storage node and therewith the write and update permissions.

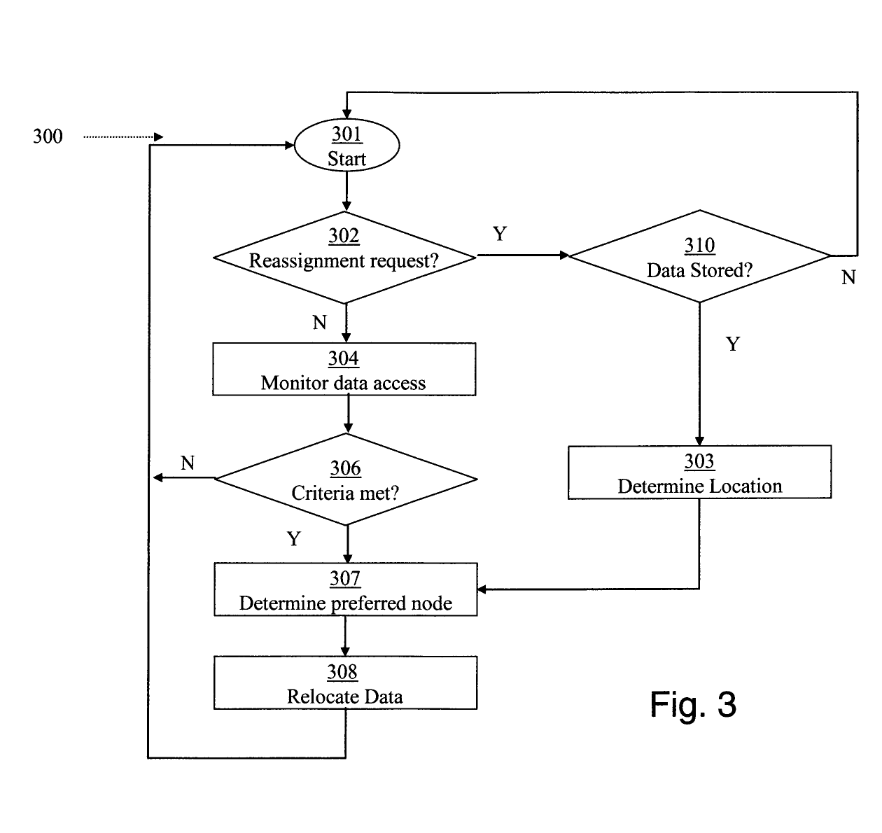

Process 300 shown in FIG. 3 represents the process for re-assigning the preferred grid node based on external signals or based on the data access pattern. An external signal may be given by a travel system 402 shown in FIG. 1. The re-assignment of the preferred storage node includes migrating the data objects pertaining to the client system and read-write permission to other grid node(s). The data migration is executed by the business application 133 using export and import commands.

Process 300 is a repetitive process implemented with the grid control processes 130 of all grid nodes comprised in system 100. The process 300 starts in step 301 and continues to step 302 where it is determined if there is a reassignment request from an external system such as travel booking system 402. The external system 402 may utilize a protocol based on TCPIP allowing to send a message to the grid control processes 130 of all or a subset of grid nodes via network 110. The message indicates the client/user name or address and the new location of the client and user respectively.

If the answer in step 302 is yes the process flows to step 310 where the grid control process 130 instructs the associated business application 133 to identify if subject client has stored data on said grid node. If the answer in step 310 is yes the process flows to step 303 where the grid control process 130 of subject node determines the location of the client/user based on said message sent by the external system 402. From step 303 the process flows to step 307 explained later. If the answer in step 310 is no the process flows back to the starting step 301.

If the answer in step 302 is no the process flows to step 304 where the data access pattern of all client systems accessing this grid node is monitored. Thereby particular attention is give to write data access causing data to be transferred to or from a distant node. For example if the user access application data from workstation 103 located in Tucson and the preferred storage node 120 for this application data is located in Mainz then all write requests have to be passed through to the storage node in Mainz causing performance decrease and utilization of expensive data lines. In this case the grid node 120 is remote to the user. This condition is determined in step 304.

From step 304 the process flows to step 306 where the data access pattern determined in step 304 is compared against predefined criteria. One criterion might be that the number of write access operations to data objects stored on a distant preferred node exceeds a certain threshold. The threshold might be 5 data write access in one minute. If the criteria in step 306 are not met then the process flows back to step 301. If the criteria in step 306 are met then the process flows to step 307 where a new preferred node is determined. Actually this step may invoke process 200, shown in FIG. 2, in order to select the new preferred node based on the client location. From step 307 the process flows to step 308.

In step 308 the data is relocated to the new preferred node determined in step 307. The relocation of the data is done by the business application 133 of the grid nodes currently storing the data to be relocated. Business application 133 may use means of exporting data to the new selected grid node during the relocation process. Relocating the data essentially copies the data and read-write permission to the new preferred node. For example, the data of a user accessing data from workstation 103 may be relocated from old preferred node 120 to new preferred node 122. In one embodiment all data for a given workstation is relocated to new preferred node. In an alternate embodiment only the last recent used data is relocated to the new preferred node. Therefore the process determines the last access date for all data stored by the given workstation and only that data is relocated where the access date is younger than a threshold date. The threshold date might be the current date minus 30 days. From step 308 the process returns to step 301.

In another embodiment all data from a given client system 102-104 are stored on the same preferred node or set of preferred nodes in a given location. The grid control processes 130 of all or a subset of grid nodes take care of this. The business application 133 keeps a reference between the data and the client and user respectively. If process 300 determines that the preferred node needs to be reassigned then all data of that client system is being migrated to the new preferred node or set of preferred nodes by instructing the business application 133 to export that data. The advantage is that the relocation of data in step 308 of process 300 is only performed from one source grid node (old preferred) to a destination grid node (new preferred node).

For many cases it is expected that a particular user travels between a limited number of different locations, for example the two locations Mainz and Tucson. A common pattern for data migration in these cases includes only a small number of different locations, in our example two. In yet another embodiment, if data is migrated from one location to another the grid control processes 130 of all or a subset of grid nodes monitor any changes to the data, such as write requests from the client. If a relocation of the data from a local (former remote) grid node to a remote (former local) node has to be performed according to process 300, only the changes of the data have to be relocated. This significantly reduces the time needed for the data migration among grid nodes and reduces overall network traffic.

Finally, the idea of the present invention is explained for the use case of a patient management system represented by grid application and storage system 100. In this example, the business application 133 running on the grid nodes manages patient records. Furthermore, client system 102 represents a hospital in Mainz and client system 104 represents a doctor practice in Schwarzenberg. Schwarzenberg is 400 km away from Mainz. The hospital 102 as well as the doctor 104 have access to the patient management system 100.

Assuming that a patient has an accident in Schwarzenberg and visits the local doctor 104, the doctor 104 in Schwarzenberg retrieves the patient records from the patient management system 100. Thereby, the doctor 104 sends a query to the grid control process 130 of all or a subset of grid nodes including the patient name. Thereupon, grid control processes 130 query the business application 133 which manages the patient records. The business application 133 pertaining to a subset of grid nodes finds data concerning that patient and returns this data to the doctor. Note, the patient records may be retrieved from a local or remote grid node.

The doctor now updates the patient records with the new findings and stores it in the patient management system 100. Thereby the data is sent to the grid control processes 130 which perform process 200 to identify the preferred node, e.g., node 122. Subsequently the data is transmitted to the business application 133 of the preferred node which stores the data. Under control of the grid control process 130 the data may be copied by the business application to a business application of another grid node, e.g., node 121.

Subsequently, the doctor transfers the patient to the hospital in Mainz 103 and initiates a corresponding travel message from his client system 104 to system 100. This message indicates that the patient is transferred to another location. This message is processed by the grid control process 130 of the preferred node 122 via process 300. Process 300 will relocate or migrate the data of said patient to another grid node in Mainz, e.g., 121. Thereby business application 133 of grid node 122 exports the data and business application 133 of grid node 121 imports that data. In this case no data may be transferred because the data was copied to grid node 121 before. When the patient subsequently arrives in the hospital in Mainz 104 the patient records are stored in a local grid node 121 which allows fast and inexpensive data access.

There may also be an external system 402 triggering a relocation of data within the patient management system 100. For example a travel booking system may inform the patient management system 100 that a patient is traveling to another location which ultimately invokes process 300. So if the patient goes on vacation and has an accident then all of his patient data is available in a fast and inexpensive way.

1. A method for storing application data in a grid application and storage system, said grid application and storage system comprising
a plurality of grid application storage nodes with at least one storage system, said grid application storage nodes being remote to each other and connected via inter-connections;
at least one application process distributed across said grid application storage nodes; and
at least one grid node control process also distributed across said grid application storage nodes, said grid node control process managing grid application storage node operations;
wherein a plurality of client systems are connected to said grid application and storage system via a network for deploying said application process and accessing application data stored on said grid application storage nodes;
said method being characterized
by determining the location of at least one client system defined for accessing the application data to be stored,
by determining the location of at least a subset of the grid application storage nodes of said grid application and storage system, and
by storing said application data on at least one selected grid application storage node of said subset, wherein the selection is based on the relation between the location of said client system and the locations of the grid application storage nodes of said subset.

2. The method according to claim 1, wherein the location of the accessing client system represents a user's current location and is determined automatically on the base of the TCPIP address, the MAC address or the name of said client system.

3. The method according to claim 1, wherein the location of the accessing client system represents a user's future location and is determined on the base of user travel information provided said via said network.

4. The method according to claim 1, wherein the criteria for selecting grid application storage nodes for storing given application data comprise:
a maximum distance between the accessing client system and a grid application storage node to be selected.

5. The method according to claim 4, wherein the criteria for selecting grid application storage nodes for storing given application data further comprise:
the number of grid application storage nodes to be selected with write/read-authority for the application data to be stored and
the number of grid application storage nodes with only read-authority for the application data to be stored.

6. (canceled)

7. (canceled)

8. The method according to claim 1, wherein application data stored on a given grid application storage node is transferred to at least one distant grid application storage node automatically, wherein the selection of said distant grid application storage node is based on the relation between its location and the location of at least one client system defined for accessing said application data.

9. The method according to claim 8, wherein said selected distant grid application storage node is provided with write/read authority for the application data to be transferred.

10. The method according to claim 8, wherein the user location is monitored when accessing given application data and wherein the transfer of said application data is initiated automatically whenever a change of the user location is determined.

11. The method according to claim 8, wherein the transfer of application data is triggered by user travel information provided via said network.

12. An infrastructure for storing application data in a grid application and storage system, said grid application and storage system comprising
a plurality of grid application storage nodes with at least one storage system, said grid application storage nodes being remote to each other and connected via inter-connections;
at least one application process distributed across said grid application storage nodes; and
at least one grid node control process also distributed across said grid application storage nodes, said grid node control process managing grid application storage node operations;
wherein a plurality of client systems are connected to said grid application and storage system via a network for deploying said application process and accessing application data stored on said grid application storage nodes;
said infrastructure being characterized
by means for determining the location of at least one client system defined for accessing the application data to be stored, said means comprising a user's electronic calendar and travel system connected to network,
by means for determining the location of at least a subset of the grid application storage nodes of said grid application and storage system, and
by means for storing said application data on at least one selected grid application storage node of said subset, wherein the selection is based on the relation between the location of said client system and the locations of the grid application storage nodes of said subset.

13. (canceled)
